(19) United States
(12) Patent Application Publication
(10) Pub. No.: US 2022/0215971 A1
(43) Pub. Date: Jul. 7, 2022

(54) DEBRIS FILTERING SKIRT ARRANGEMENT FOR NUCLEAR FUEL ASSEMBLY BOTTOM NOZZLE AND BOTTOM NOZZLE INCLUDING SAME

(71) Applicant: Westinghouse Electric Company LLC, Cranberry Township, PA (US)

(72) Inventors: David S. HUEGEL, Blythewood, SC (US); Yuriy ALESHIN, Cayce, SC (US); Caroline K. DUNCAN, Columbia, SC (US); Robert A. BREWSTER, Mars, PA (US); Artem ALESHIN, Columbia, SC (US)

(73) Assignee: Westinghouse Electric Company LLC, Cranberry Township, PA (US)

(21) Appl. No.: 17/595,499

(22) PCT Filed: May 22, 2020
(86) PCT No.: PCT/US2020/034282

§ 371 Date: Nov. 17, 2021

Related U.S. Application Data
(60) Provisional application No. 62/851,835, filed on May 23, 2019.

(51) Int. Cl. G21C 3/12; B01D 29/33; G21C 3/32; G21C 3/33

(52) U.S. Cl. CPC G21C 3/12; G21C 3/3305; G21C 3/3206; B01D 29/33

(57) ABSTRACT

A debris filtering skirt configured for use with a flow plate of a bottom nozzle of a nuclear reactor is disclosed herein. The debris filtering skirt includes a base portion defining an opening between a bottom edge and a reactor vessel lower core plate, and the opening includes a dimension configured to position the bottom nozzle a predetermined distance away from the reactor vessel lower core plate. The debris filtering skirt also includes a plurality of holes, and at least one hole of the plurality of holes includes a dimension determined based, at least in part, on a predetermined size of debris capable of traversing through the inlet and the outlet. The dimension of the opening and the dimension of the at least one hole are determined based, at least in part, on a predetermined loss coefficient of the bottom nozzle.

### CROSS-REFERENCE

This application claims priority to U.S. Provisional Patent Application No. 62/851,835, which was filed on May 23, 2019. The contents of which is incorporated by reference into this specification.

### FIELD

The present invention relates generally to nuclear reactors and, more particularly, is concerned with debris filtering skirt arrangements for bottom nozzles for use in a nuclear fuel assembly such as employed in a pressurized water reactor (PWR).

### BACKGROUND

During manufacture and subsequent installation and repair of components comprising a nuclear reactor coolant circulation system, diligent effort is made to assure removal of debris from the reactor vessel and its associated systems which circulate coolant through it under various operating conditions before it can reach the nuclear fuel assembly bundle region. Although elaborate procedures are carried out to help assure debris removal, experience shows that in spite of the safeguards used to affect such removal, some small amount of debris, such as metal chips and metal particles still remain hidden in the systems. Most of the debris consists of metal wires, chips and turnings which were probably left in the primary system after steam generator repair or replacement or similar types of plant modifications during the refueling process. Therefore, it is desirable to ensure that this type of debris does not make its way into the fuel assembly bundle region during plant operation. However, existing bottom nozzles and side skirts are not specifically configured to mitigate the introduction of debris into the reactor core.

For example, existing fuel assembly bottom nozzle side skirt designs have a large opening (˜5″×˜1″ per side) through which debris can easily pass and travel around the current fuel assembly bottom nozzle designs into the gap between fuel assemblies and into the fuel bundle region where debris-induced fuel fretting failures can occur. Altering the geometry of the fuel assembly to reduce the amount of debris that can pass through can increase the loss coefficient of the fuel assembly and obstruct the flow into the reactor vessel baffle-barrel region, adversely impacting the cooling of the reactor vessel former plates.

Accordingly, a need exists for improved solutions to the problem of debris filtering in nuclear reactors. New approaches must be compatible with the existing structure and operation of the components of the reactor, be effective throughout the operating cycle of the reactor, and at least provide overall benefits which outweigh any costs added.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a debris filtering skirt configured for use with a flow plate of a bottom nozzle configured to be positioned on the reactor vessel lower core plate in a nuclear reactor is disclosed. The debris filtering skirt includes a base portion including a first surface, a second surface, a bottom edge, and a plurality of sides, wherein the base portion defines an opening between the bottom edge and the reactor vessel lower core plate. The opening includes a dimension configured to position the bottom nozzle a predetermined distance away from the reactor vessel lower core plate, and a plurality of holes defined within at least one side of the plurality of sides of the base portion. Each hole of the plurality of holes includes an inlet proximal to the first surface of the base portion and an outlet proximal to the second surface of the base portion, and at least one hole of the plurality of holes includes a dimension determined based, at least in part, on a predetermined size of debris capable of traversing through the at least one hole. The dimension of the opening and the dimension of the at least one hole are determined based, at least in part, on a predetermined loss coefficient of the bottom nozzle.

In various aspects, a fuel assembly configured for selective engagement with the reactor vessel lower core plate of a nuclear reactor is disclosed. The fuel assembly includes a bottom nozzle including a flow plate. The flow plate includes a plurality of flow passages through which the majority of the reactor coolant can traverse towards the core region of the nuclear reactor, and a debris filtering skirt including a base portion including a plurality of holes and a bottom edge. The base portion further defines an opening between the bottom edge of the bottom nozzle and the reactor vessel lower core plate which the fuel assembly sits on, and the opening includes a dimension configured to position the bottom edge a predetermined distance away from the reactor vessel lower core plate when the fuel assembly is selectively engaged with the reactor vessel lower core plate. At least one hole of the plurality of holes includes a dimension determined based, at least in part, on a predetermined size of debris capable of traversing through from the inlet to the outlet. The dimension of the opening and the dimension of the at least one hole are determined based, at least in part, on a predetermined loss coefficient of the bottom nozzle.

In various aspects, a method of manufacturing a debris filtering skirt of a bottom nozzle configured for selective engagement with a reactor vessel lower core plate of a nuclear reactor is disclosed. The method includes determining a maximum loss coefficient of the bottom nozzle, determining a minimum filtration capability of the debris filtering skirt, calculating a first dimension based at least in part on the maximum loss coefficient and the minimum filtration capability, calculating a second dimension based at least in part on the maximum loss coefficient, producing the bottom nozzle, producing the debris filtering skirt including a bottom edge and a plurality of sides, and defining a plurality of holes in at least one side of the plurality of sides of the debris filtering skirt. At least one hole of the plurality of holes includes the first dimension, defining an opening within the debris filtering skirt, and the opening includes the second dimension such that, when the bottom nozzle is selectively coupled to the reactor vessel lower core plate, the bottom edge of debris filtering skirt is positioned the second dimension away from a surface of the reactor vessel lower core plate.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of various aspects described herein, together with the advantages of such features, can be understood in accordance with the following description taken in conjunction with the accompanying drawings, as follows:

FIG. 1 illustrates a partial cross-section of a side view of a fuel assembly including a debris filter bottom nozzle.

FIG. 2 illustrates a isometric view of the debris filter bottom nozzle of the fuel assembly of FIG. 1.

FIG. 3 illustrates an isometric view of a debris filter bottom nozzle according to at least one aspect of the present disclosure.

FIG. 4 illustrates an isometric view of a filtering skirt arrangement of FIG. 3, wherein a top plate of the debris filter bottom nozzle has been removed to further illustrate its internal geometry.

Corresponding reference characters indicate corresponding parts throughout the drawings. The drawings set out herein illustrate various aspects in one form and such aspects are not to be construed as limiting the scope of the disclosure in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”. “upwardly”, “downwardly”, and the like are words of convenience and are not to be construed as limiting terms.

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

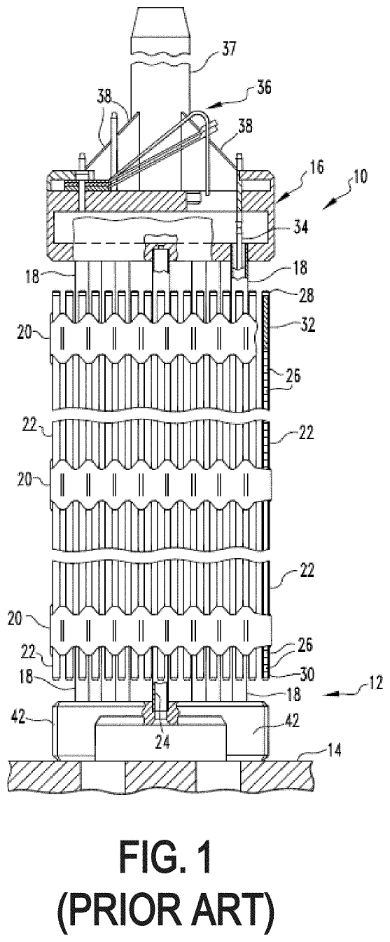

Referring now to FIG. 1, a side view of a known fuel assembly 10, in which various non-limiting aspects of the present disclosure can be employed, is illustrated in vertically foreshortened form. For example, the fuel assembly 10 can be used in a pressurized water reactor and has a structural skeleton which at its lower end includes a debris filter bottom nozzle 12 such as described in U.S. Pat. No. 4,900,507, the disclosure of which is herein incorporated by reference in its entirety. The bottom nozzle 12 can support the fuel assembly 10 on a reactor vessel lower core plate 14 in the core region of a reactor (not shown). The term “reactor vessel” is used broadly herein and can include for example, the fuel assembly of a nuclear reactor. In addition to the bottom nozzle 12, the structural skeleton of the fuel assembly 10 can also include a top nozzle 16 at its upper end and a number of guide thimble tubes 18 which extend longitudinally between the bottom and top nozzles 12,16 and at opposite ends are attached thereto. Although the improved debris filter skit and bottom nozzle can be implemented in the fuel assembly 10 of FIG. 1, the present disclosure contemplates other non-limiting aspects involving alternate fuel assemblies. For example, the skirt can employ similar geometric features to be discussed herein, modified to accommodate any fuel assembly for which the reduction of debris is a priority.

The fuel assembly 10 can further include a plurality of transverse grids 20 that can be axially spaced along and/or mounted to the guide thimbles 18 and an organized array of elongated fuel rods 22 can be transversely spaced and/or supported by the grids 20. Also, the assembly 10 can have an instrumentation tube 24 located in the center thereof and extending between and mounted to the bottom and top nozzles 12,16. With such an arrangement of parts, the fuel assembly 10 can form an integral unit capable of being conveniently handled without damaging the assembly parts.

As mentioned above, the fuel rods 22 of FIG. 1 of fuel assembly 10 can be held in spaced relationship with one another by the grids 20 spaced along the fuel assembly length. Each fuel rod 22 includes nuclear fuel pellets 26 and is closed at its opposite ends by an upper end plug 28 and a lower end plug 30. For example, the pellets 26 can be maintained in a stack by a plenum spring 32 disposed between the upper end plug 28 and the top of the pellet stack. However, in other non-limiting aspects the pellets 26 can be otherwise configured via alternate mechanisms. In the non-limiting aspect of FIG. 1, the fuel pellets 26 can be composed of a fissile material capable of creating the reactive power of the reactor. However, in other non-limiting aspects of the present disclosure, the pellets 26 can include a variety of suitable materials capable of generating reactive power. Additionally, a liquid moderator/coolant such as water, or water containing boron, is pumped upwardly through a plurality of flow openings in the lower core plate 14 to the fuel assembly. In still other non-limiting aspects, alternate coolants can be used to a similar effect. The bottom nozzle 12 of the fuel assembly 10 can pass the coolant flow along to the fuel rods 22 of the assembly in order to extract heat generated therein for the production of useful work.

In order to control the fission process, a number of control rods 34 can be reciprocally moved within the fuel assembly 10 of FIG. 1. For example, the rods 34 can be reciprocally moved in the guide thimble tubes 18 located at predetermined positions in the fuel assembly 10. Accordingly, a rod cluster control mechanism 36 can be positioned above the top nozzle 16 to support the control rods 34. In the fuel assembly 10 of FIG. 1, the control mechanism can include an internally threaded cylindrical member 37 with a plurality of radially extending flukes or arms 38. Each arm 38 can be interconnected to a control rod 34 such that the control mechanism 36 can be operable to move the control rods vertically in the guide thimbles 18 to thereby control the fission process in the fuel assembly 10, all in a well-known manner.

As mentioned above, a fuel assembly, such as the fuel assembly 10 of FIG. 1, can be damaged—by debris that gets trapped at or below the grids 20. To prevent occurrence of such damage, it is highly desirable to prevent such debris from passing through the bottom nozzle flow holes or under the side skirts and between the fuel assemblies and reaching the fuel bundle region.

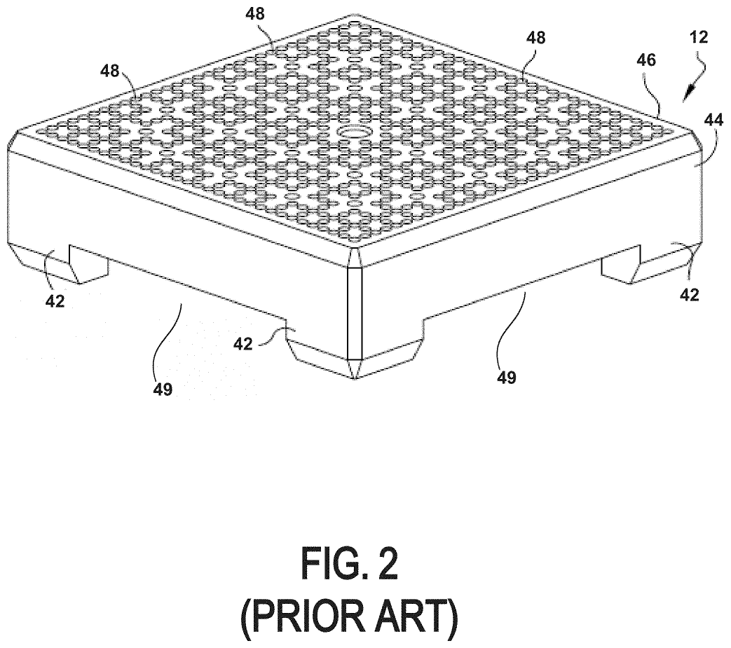

Referring now to FIG. 2, the bottom nozzle 12 can include support means, which can take the form of a plurality of corner legs 42 that can extend from a generally rectangular skirt portion 44. The corner legs 42 can support the fuel assembly 10 on the reactor vessel lower core plate 14. Bottom nozzle 12 can further include a generally rectangular planar plate 46 which is suitably attached to the skirt portion 44. Although the rectangular planar plate 46 of the non-limiting aspect of FIG. 2 is welded to the bottom nozzle 12, other non-limiting aspects of the present disclosure contemplate alternate means of attaching the rectangular planar plate 46 to the bottom nozzle 12. In still other non-limiting aspects, the rectangular planar plate 46 is integrally formed with the bottom nozzle 12 through procedures including but not limited to additive manufacturing.

The bottom nozzle 12 of FIG. 2 can further include a plate 46 with a plurality of spaced flow holes 48. The flow holes 48 can be sized to “filter out” debris of a damaging size. Such a design is intended to perform such filtering without appreciably affecting flow or pressure drop through the plate 46 and the fuel assembly 10. However, as indicated in FIG. 2, and previously discussed in the Background section, such bottom nozzle 12 arrangements accommodate flow and pressure drop by including rather large openings through which debris may readily pass. Thus, it would be advantageous to implement a debris filter skirt and/or improved bottom nozzle 12 that can filter debris of a concerning size while preserving the flow of coolant and minimizing pressure drop through the plate 46.

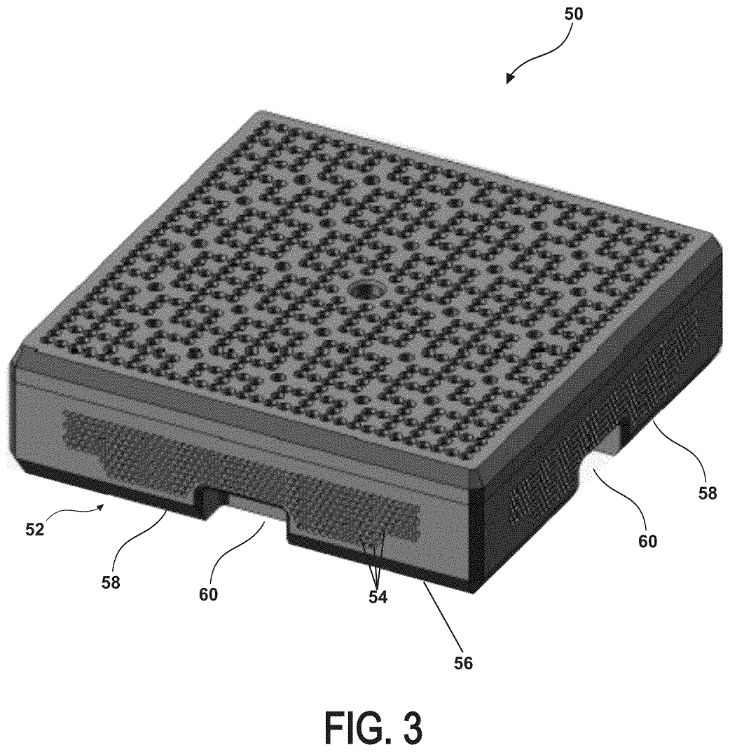

Having thus described an example of an arrangement in which aspects of the present disclosure can be implemented, a bottom nozzle having a side skirt design in accordance with at least one non-limiting aspect of the present disclosure will now be described. Referring now to FIG. 3, an improved bottom nozzle 50 can include an improved skirt 52, which can be manufactured using existing manufacturing technologies, combined with a top plate 46 (FIG. 2) to form a single, integral bottom nozzle 50. However, in other non-limiting aspects, the improved bottom nozzle 50 and skirt 52 can be manufactured using less conventional procedures. For example, the bottom nozzle 50 and skirt 52 might be integrally formed using additive manufacturing processes. The skirt 52 can include a plurality of skirt flow holes 54 on one or more sides, which facilitates a lateral flow of coolant underneath the improved bottom nozzle 50 and through the plurality of the skirt flow holes.

According to the non-limiting aspect of FIG. 3, the improved bottom nozzle 50 and side skirt 52 includes an enhanced debris filtering capability due to a reduced gap between the reactor vessel lower core plate (not shown) and a bottom edge 56 of the skirt 52, and a specifically configured plurality of flow holes 54 on the side skirt 52 of the bottom nozzle 50. As depicted in the aspect of FIG. 3, the side skirts 52 have been lowered such that a gap or opening 58 between the bottom nozzle 50 and the reactor vessel lower core plate (not shown) is reduced to about 0.0″ to 0.150″ (instead of about 1″ such as previously discussed in reference to FIG. 2). However, in other non-limiting aspects, the opening 58 and the configuration of flow holes 54 are configured to a variety of dimensions and designs to achieve the desired filtering capability. Notably, the opening 58 of the bottom nozzle 50 of FIG. 3 has been substantially reduced in comparison to the opening 49 illustrated in the aspect of FIG. 2, because of the plurality of flow holes 54 of the side skirt 52. In the aspect of FIG. 3, the side skirt flow holes 54 can include a diameter of about 0.020″ to 0.150″ defined within the side skirts 52. However, it is to be appreciated that the side skirt 52 flow holes 54 may be a variety of different shapes (e.g., round, oval, etc.) and/or sizes without varying from the scope of the disclosed aspect of FIG. 3. It is also to be appreciated that one or more of the quantity, pattern, and/or pitch (e.g., square, triangular, etc.) of the side skirt flow holes may be varied without varying from the scope of the disclosed aspect of FIG. 3.

The reduction in the size of the skirt 52 opening 58 as compared to the prior art design of FIG. 2 can be accomplished because the flow around the bottom nozzle 50 is largely defined by the gaps between adjacent bottom nozzles (not shown) which is smaller than the larger openings 49 in the side skirts of the prior art bottom nozzle 12 design of FIG. 2. Despite the opening 58 being configured to a smaller size and the introduction of the plurality of flow holes 54, both of which enhance the filtering capability of the improved bottom nozzle 50, the side skirt design 52 of FIG. 3 does not adversely affect a pressure loss coefficient of the bottom nozzle 50. This is due to the geometric features of the skirt 52 design being specifically configured to compensate for the reduction in size of the opening 58 and/or the introduction of the plurality of filtering flow holes 54. Geometric features including but not limited to a length of each flow hole 54 and/or a diameter of each flow holes 54 can be specifically configured such that the bottom nozzle 50 maintains a predetermined loss coefficient (i.e., pressure loss) in spite of its improved filtering capabilities. For example, the Darcy-Weisbach equation can be used to calculate a pressure loss along the flow passage:

$$Δ p = L \cdot {f}_{d} \cdot \frac{ρ}{2} \cdot \frac{{v}^{2}}{D}$$

Where Δp is the pressure loss through the flow passage 12, L is a length of the flow passage 12, f_{D} is a darcy friction factor of the flow passage 12, ρ is a density of the fluid traversing the flow passage 12, ν is an average velocity of a fluid traversing the flow passage 12, and D is a flow diameter of the flow passage 12. The Darcy-Weisbach equation is merely illustrative, and other aspects employ a variety of fluid dynamics computations to optimize the bottom nozzle 50 and side skirt 52 design. However, according to some non-limiting aspects of the present disclosure, the specific geometry of the skirt 52 might not lend itself to the direct use of the Darcy-Weisbach equation, as the flow holes 48 and the top flow plate 46 through which the majority of the flow passes can remain unchanged. Since the present disclosure contemplates improvements to secondary flow paths, such as those through the bottom nozzle, Computational Fluid Dynamics (CFD) can be utilized to calculate and optimize the flow through the flow holes 54 of the side skirt 52. This ensures that there is sufficient flow into the gaps between fuel assemblies as well as into the reactor vessel baffle-barrel region to ensure that the reactor vessel former plates are sufficiently cooled.

For example, in one non-limiting aspect of the present disclosure, the geometry and features of the skirt 52 can be specifically configured to achieve a predetermined loss coefficient of the bottom nozzle 50 that is greater than or equal to about 1.0 and less than or equal to about 2.5. However, in other non-limiting aspects, the skirt 52 can be further configured to achieve any desired loss coefficient through the bottom nozzle 50. Alternatively and/or additionally, the skirt 52 can be configured to control the change in loss coefficient compared to those of conventional bottom nozzles. For example, in some non-limiting aspects, the geometry of the skirt 52 can be configured to achieve a loss coefficient no greater than 0-5% different than that of a conventional bottom nozzle. In still other non-limiting aspects, the skirt 52 can be specifically configured to achieve a loss coefficient that differs from the loss coefficient of a conventional bottom nozzle to varying degrees, depending on the intended application and/or preference of the user. Accordingly, the improved bottom nozzle 50 and side skirt 52 design of FIG. 3 can achieve any desired flow characteristic of a lateral flow while filtering out debris of a predetermined size before it can reach the fuel bundle region and potentially cause damage.

According to other non-limiting aspects of the present disclosure, a variety of geometric features of the bottom nozzle 50 and skirt 52 can be specifically configured to effect other flow characteristics while filtering debris of varying sizes. For example, the dimensions of the opening 58 can be specifically tailored to achieve predetermined filtration and loss coefficient characteristics. In still other non-limiting aspects, the improved bottom nozzle 50 and debris filtering side skirt 52 can be particularly configured to improve the debris filtering efficiency of the bottom nozzle 12 of FIG. 2 while maintaining existing design requirements, including but not limited to pressure drop, structural support, and the ability to ensure that sufficient flow reaches the baffle-barrel region for the purposes of cooling the reactor vessel former plates.

Furthermore, many nuclear reactor designs include bolts that are located on the reactor vessel lower core plate (not shown) in areas that can directly interfere with and prevent the lowering of the bottom nozzle 12 and side skirt 44 of FIG. 2. However, the improved bottom nozzle 50 and side skirt 52 can further include features that accommodate for such bolts. For example, the improved bottom nozzle 50 and side skirt 52 of FIG. 3 include four pockets 60, which are specifically positioned in the side skirt 52 to prevent the bottom nozzle 50 and side skirt 52 from directly interfering with the lower core plate bolts (not shown). This is accomplished while simultaneously providing the greatly improved debris protection and desirable flow characteristics, as previously discussed. In the non-limiting aspect of FIG. 3, the pocket width can be varied between about 1.5″ and 2.0″, the pocket height can be varied between about 0.50″ and 1.0″, and the pocket depth can be varied between about 0.80″ and 1.20″. However, the present disclosure further contemplates non-limiting aspects including pockets of varying dimensions configured to accommodate a wide variety of bolt configurations and lower core plate designs. Accordingly, the improved bottom nozzle 50 and side skirt 52 of FIG. 3 can be further altered such that the improved filtration capabilities and flow characteristics can be implemented on a wide variety of reactor designs.

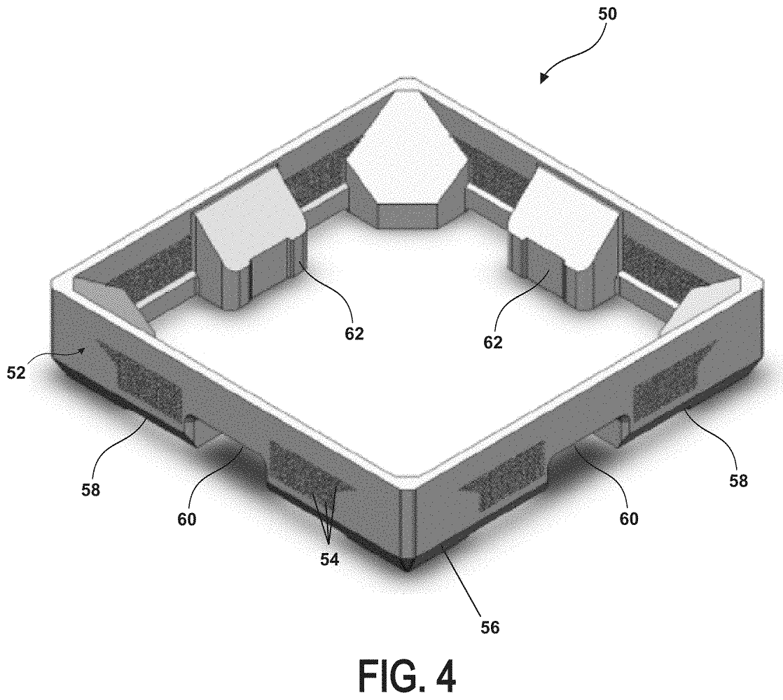

Referring now to FIG. 4, the improved bottom nozzle 50 of FIG. 3 is illustrated without the top plate 46 of FIG. 2 to further illustrate an internal geometry of the improved side skirt 52. Specifically, the pockets 60 as depicted in FIG. 3 are shown to include a recess 62 formed in a back wall thereof on the side opposite the pocket. Accordingly, the recesses 62 can provide a requisite clearance for guide thimble screws (not shown) to support the manufacture and/or maintenance of a fuel assembly, such as the fuel assembly 10 of FIG. 1. Furthermore, the pockets 60 of FIGS. 3 and 4 can also allow one such fuel assembly 10 to be lifted off of the reactor vessel lower core plate (not shown) in situations where the fuel assembly 10 is stuck to the reactor vessel lower core plate (FIG. 1).

In further reference of FIGS. 3 and 4, the improved bottom nozzle 50 can be manufactured using conventional manufacturing techniques such that the improved side skirt 52 is integral to the bottom nozzle 50. Accordingly, the bottom nozzle 50 can be initially produced to include the aforementioned filtration and flow benefits. For example, in some non-limiting aspects of the present disclosure, the improved bottom nozzle 50 and side skirt 52 can be produced using additive manufacturing techniques. Such an approach can provide for even enhanced filtration benefits because the plurality of flow holes 54 can be produced with much smaller dimensions. Additionally, and/or alternatively, additive manufacturing techniques can enable non-line-of-sight flow holes 54 to be produced, thereby further enhancing the filtration capabilities of the bottom nozzle 50.

However, the present disclosure contemplates other non-limiting aspects wherein the improved bottom nozzle 50 and side skirt 52 of FIGS. 3 and 4 are independently manufactured and subsequently attached to one another. For example, an independently produced side skirt 52 can be attached to the bottom nozzle 12 of FIG. 2. Thus, even the known bottom nozzle 12 of FIG. 2 can be retrofitted with the improved side skirt 52 to achieve the aforementioned benefits of filtration and flow. As an additional benefit, the improved side skirt 52 design of FIGS. 3 and 4 does not require the alteration of conventional fuel assembly 10 (FIG. 1) manufacturing processes, thereby further facilitating the ability to retrofit known bottom nozzles 12.

Various aspects of the subject matter described herein are set out in the following numbered clauses:

Clause 1: A debris filtering side skirt configured for use with a flow plate of a bottom nozzle configured to be positioned on the reactor vessel lower core plate of a nuclear reactor, the debris filtering skirt including a base portion including a first surface, a second surface, a bottom edge, and a plurality of sides, wherein the base portion defines an opening between the bottom edge and the reactor vessel lower core plate of the nuclear reactor, wherein the opening includes a dimension configured to position the bottom nozzle a predetermined distance away from the reactor vessel lower core plate of the nuclear reactor, and a plurality of holes defined within at least one side of the plurality of sides of the base portion, wherein each hole of the plurality of holes includes an inlet proximal to the first surface of the base portion and an outlet proximal to the second surface of the base portion, and wherein at least one hole of the plurality of holes includes a dimension determined based, at least in part, on a predetermined size of debris capable of traversing through the inlet and the outlet, wherein the dimension of the opening and the dimension of the at least one hole are determined based, at least in part, on a predetermined loss coefficient of the bottom nozzle.

Clause 2: A debris filtering skirt according to clause 1, wherein the debris filtering skirt is integrally formed with the bottom nozzle, and wherein the debris filtering skirt and bottom nozzle constitute a single-piece unit.

Clause 3: A debris filtering skirt according to clauses 1 or 2, wherein the debris filtering skirt is a separately formed piece that is configured for selective engagement with the bottom nozzle.

Clause 4: A debris filtering skirt according to any of clauses 1-3, wherein the base portion is configured for selective engagement with the reactor vessel lower core plate.

Clause 5: A debris filtering skirt according to any of clauses 1-4, further including a pocket proximal to the first side of the base portion, wherein the pocket is configured to circumvent a bolt of the reactor vessel lower core plate, such that the bolt does not mechanically interfere with the selective engagement of the base portion and the reactor vessel lower core plate.

Clause 6: A debris filtering skirt according to any of clauses 1-5, wherein the pocket further includes a handle configured to allow a user to disengage the fuel assembly from the reactor vessel lower core plate.

Clause 7: A debris filtering skirt according to any of clauses 1-6, further including a recess proximal to the second surface, wherein the recess is configured to provide a predetermined clearance for a guide thimble screw of the fuel assembly.

Clause 8: A debris filtering skirt according to any of clauses 1-7, wherein the plurality of holes is defined in each side of the plurality of sides of the base portion.

Clause 9: A debris filtering skirt according to any of clauses 1-8, wherein the predetermined loss coefficient of the bottom nozzle is greater than or equal to 1.0 and less than or equal to 2.5.

Clause 10: A debris filtering skirt according to any of clauses 1-9, wherein the predetermined distance is less than or equal to 0.150 inches.

Clause 11: A debris filtering skirt according to any of clauses 1-10, wherein the dimension of the at least one hole of the plurality of holes is greater than or equal to 0.020 inches and less than or equal to 0.150 inches.

Clause 12: A fuel assembly configured for selective engagement with a reactor vessel lower core plate of a nuclear reactor, the fuel assembly including a bottom nozzle including a flow plate, wherein the flow plate includes a plurality of flow passages through which a coolant can traverse towards the core region of the nuclear reactor, and a debris filtering skirt including a base portion including a plurality of holes and a bottom edge, wherein the base portion defines an opening between the bottom edge and the reactor vessel lower core plate of the nuclear reactor, wherein the opening includes a dimension configured to position the bottom edge a predetermined distance away from the reactor vessel lower core plate when the fuel assembly is selectively engaged with the reactor vessel lower core plate, and wherein at least one hole of the plurality of holes includes a dimension determined based, at least in part, on a predetermined size of debris capable of traversing through the at least one hole, wherein the dimension of the opening and the dimension of the at least one hole are determined based, at least in part, on a predetermined loss coefficient of the bottom nozzle.

Clause 13: A fuel assembly according to clause 12, wherein the predetermined loss coefficient of the bottom nozzle is greater than or equal to 1.0 and less than or equal to 2.5.

Clause 14: A fuel assembly according to clause 12 or 13, wherein the predetermined distance is less than or equal to 0.150 inches.

Clause 15: A fuel assembly according to any of clauses 12-14, wherein the dimension of the at least one hole of the plurality of holes is greater than or equal to 0.020 inches and less than or equal to 0.150 inches.

Clause 16: A fuel assembly according to any of clauses 12-15, wherein the flow passage and plurality of filtering ligaments are co-formed with the debris filter bottom nozzle and constitute a single-piece unit.

Clause 17: A fuel assembly according to any of clauses 12-16, wherein the debris filtering skirt further includes a pocket configured to circumvent a bolt of the lower core plate, such that the bolt does not mechanically interfere with the selective engagement of the base portion and the lower core plate: and a recess positioned opposite the pocket, wherein the recess is configured to provide a predetermined clearance for a guide thimble screw of the fuel assembly.

Clause 18: A method of manufacturing a debris filtering skirt of a bottom nozzle configured for selective engagement with the reactor vessel lower core plate of a nuclear reactor, the method including determining a maximum loss coefficient of the bottom nozzle, determining a minimum filtration capability of the debris filtering skirt, calculating a first dimension based at least in part on the maximum loss coefficient and the minimum filtration capability, calculating a second dimension based at least in part on the maximum loss coefficient, producing the bottom nozzle, producing the debris filtering skirt including a bottom edge and a plurality of sides, defining a plurality of holes in at least one side of the plurality of sides of the debris filtering skirt, wherein at least one hole of the plurality of holes includes the first dimension, defining an opening within the debris filtering skirt, wherein the opening includes the second dimension such that, when the bottom nozzle is selectively coupled to the lower core plate, the bottom edge of debris filtering skirt is positioned the second dimension away from a surface of the reactor vessel lower core plate.

Clause 19: A method according to clause 18, wherein the first dimension is greater than or equal to 0.020 inches and less than or equal to 0.150 inches, and wherein the second dimension is less than or equal to 0.150 inches.

Clause 20: A method according to clause 18 or 19, wherein the bottom nozzle and debris filtering skirt are produced using additive manufacturing techniques such that the debris filtering skirt and bottom nozzle are co-formed and constitute a single-piece unit.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art w % ill recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A. B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A. B, or C” would include but not be limited to systems that have A alone, B alone, C alone, A and B together, A and C together, B and C together, and/or A. B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect.” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 20%, 15%, 10%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

1. A debris filtering skirt configured for use with a flow plate of a bottom nozzle configured to be positioned on a reactor vessel lower core plate in a nuclear reactor, the debris filtering skirt comprising:
a base portion comprising a first surface, a second surface, a bottom edge, and a plurality of sides, wherein the base portion defines an opening between the bottom edge and the reactor vessel lower core plate, wherein the opening comprises a dimension configured to position the bottom nozzle a predetermined distance away from the reactor vessel lower core plate; and
a plurality of holes defined within at least one side of the plurality of sides of the base portion, wherein each hole of the plurality of holes comprises an inlet proximal to the first surface of the base portion and an outlet proximal to the second surface of the base portion, and wherein at least one hole of the plurality of holes comprises a dimension determined based, at least in part, on a predetermined size of debris capable of traversing through the inlet and the outlet;
wherein the dimension of the opening and the dimension of the at least one hole are determined based, at least in part, on a predetermined loss coefficient of the bottom nozzle.

2. The debris filtering skirt of claim 1, wherein the debris filtering skirt is integrally formed with the bottom nozzle, and wherein the debris filtering skirt and bottom nozzle constitute a single-piece unit.

3. The debris filtering skirt of claim 1, wherein the debris filtering skirt comprises a separately formed piece that is configured for selective engagement with the bottom nozzle.

4. The debris filtering skirt of claim 1, wherein the base portion is configured for selective engagement with the reactor vessel lower core plate.

5. The debris filtering skirt of claim 4, further comprising a pocket proximal to the first side of the base portion, wherein the pocket is configured to circumvent a bolt of the lower core plate, such that the bolt does not mechanically interfere with the selective engagement of the base portion and the lower core plate.

6. The debris filtering skirt of claim 5, wherein the pocket further comprises a handle configured to allow a user to disengage the fuel assembly from the lower core plate.

7. The debris filtering skirt of claim 5, further comprising a recess proximal to the second surface, wherein the recess is configured to provide a predetermined clearance for a guide thimble screw of the fuel assembly.

8. The debris filtering skirt of claim 1, wherein the plurality of holes is defined in each side of the plurality of sides of the base portion.

9. The debris filtering skirt of claim 1, wherein the predetermined loss coefficient of the bottom nozzle is greater than or equal to 1.0 and less than or equal to 2.5.

10. The debris filtering skirt of claim 1, wherein the predetermined distance is less than or equal to 0.150 inches.

11. The debris filtering skirt of claim 1, wherein the dimension of the at least one hole of the plurality of holes is greater than or equal to 0.020 inches and less than or equal to 0.150 inches.

12. A fuel assembly configured for selective engagement with a lower core plate of a nuclear reactor, the fuel assembly comprising:
a bottom nozzle comprising a flow plate, wherein the flow plate comprises a plurality of flow passages through which a coolant can traverse towards a core region of the nuclear reactor; and
a debris filtering skirt comprising a base portion comprising a plurality of holes and a bottom edge, wherein the base portion defines an opening between the bottom edge and the reactor vessel lower core plate, wherein the opening comprises a dimension configured to position the bottom edge a predetermined distance away from the lower core plate when the fuel assembly is selectively engaged with the lower core plate, and wherein at least one hole of the plurality of holes comprises a dimension determined based, at least in part, on a predetermined size of debris capable of traversing through the at least one hole;
wherein the dimension of the opening and the dimension of the at least one hole is determined based, at least in part, on a predetermined loss coefficient of the bottom nozzle.

13. The fuel assembly of claim 12, wherein the predetermined loss coefficient of the bottom nozzle is greater than or equal to 1.0 and less than or equal to 2.5.

14. The fuel assembly of claim 12, wherein the predetermined distance is less than or equal to 0.150 inches.

15. The fuel assembly of claim 12, wherein the dimension of the at least one hole of the plurality of holes is greater than or equal to 0.020 inches and less than or equal to 0.150 inches.

16. The fuel assembly of claim 12, wherein the debris filtering skirt is integrally formed with the bottom nozzle, and wherein the debris filtering skirt and bottom nozzle constitute a single-piece unit.

17. The fuel assembly of claim 12, wherein the debris filtering skirt further comprises:
a pocket configured to circumvent a bolt of the lower core plate, such that the bolt does not mechanically interfere with the selective engagement of the base portion and the lower core plate; and
a recess positioned opposite the pocket, wherein the recess is configured to provide a predetermined clearance for a guide thimble screw of the fuel assembly.

18. A method of manufacturing a debris filtering skirt of a bottom nozzle configured for selective engagement with a reactor vessel lower core plate of a nuclear reactor, the method comprising:
determining a maximum loss coefficient of the bottom nozzle;
determining a minimum filtration capability of the debris filtering skirt;
calculating a first dimension based at least in part on the maximum loss coefficient and the minimum filtration capability;
calculating a second dimension based at least in part on the maximum loss coefficient;
producing the bottom nozzle;
producing the debris filtering skirt comprising a bottom edge and a plurality of sides;
defining a plurality of holes in at least one side of the plurality of sides of the debris filtering skirt, wherein at least one hole of the plurality of holes comprises the first dimension;
defining an opening within the debris filtering skirt, wherein the opening comprises the second dimension such that, when the bottom nozzle is selectively coupled to the lower core plate, the bottom edge of debris filtering skirt is positioned the second dimension away from a surface of the lower core plate.

19. The method of claim 18, wherein the first dimension is greater than or equal to 0.020 inches and less than or equal to 0.150 inches, and wherein the second dimension is less than or equal to 0.150 inches.

20. The method of claim 18, wherein the bottom nozzle and debris filtering skirt are produced using additive manufacturing techniques such that the debris filtering skirt and bottom nozzle are co-formed and constitute a single-piece unit.
